(19) United States
(12) Patent Application Publication
(10) Pub. No.: US 2002/0133914 A1
(43) Pub. Date: Sep. 26, 2002

(54) Eyeglass retainer with an improved end fastener

(76) Inventors: John Scott, Wilson, WY (US); Jack Koehler, Jackson, WY (US)

Correspondence Address: ANDREW D. MASLOW, 275 WEST 96TH STREET #20E, NEW YORK, NY, 10025, US

(21) Appl. No.: 09/815,168

(22) Filed: Mar. 22, 2001

(51) Int. Cl. G02C 3/00; G02C 11/00

(52) U.S. Cl. 24/3.3

(57) ABSTRACT

An eyeglass retainer is provided with an improved end fastener. The end fastener is attached to the end of a cord and to the temple of eyeglasses. The end fastener is made from a unitary body of elastomeric material and forms a first tube along a first axis. The first tube is adapted to accept the temple of the eyeglasses. The end fastener also forms a second tube along a second axis. The said second tube is adapted to receive said cord and is molded to said cord.

### BACKGROUND OF THE INVENTION

1. Field of the Invention

This invention relates to eyeglass retainers used to secure a pair of eyeglasses to the head of the wearer. In particular, the invention relates to an improved eyeglass retainer that grips the temples of the eyeglass more securely.

2. Background of the Invention

In the prior art various retainers for eyeglasses have been advanced which hold eyeglasses through the use of a band around the head. Theses devices have worked well in many instances but sometimes fail to be both comfortable and securely hold the eyeglasses in position for use.

U.S. Pat. No. 4,133,604 discloses the basic state of the art eyeglass retainer which is comfortable and securely holds the eyeglasses in position. This patent discloses the use of a unitary piece of a foam material which has been formed into tubes at both ends. The inner portion of the tubes is lined with an elastic woven material. The tubes grip the temples of the eyeglass retainer through an action similar to a “chinese finger trap” wherein a tension placed on the tube will tighten it down or tend to make it of smaller diameter, while compression will tend to extend it. However, this eyeglass retainer becomes less effective when the circumference of the temples of the eyeglass being held is reduced, such as in wire rimmed eyeglasses. Since the inner circumference of the tubes is fixed, this eyeglass retainer has the disadvantage of working effectively on a small range of sizes of temples. If the circumference of the inside of the tube is reduced, then the retainer will not fit easily or at all onto eyeglasses with large temples.

U.S. Pat. No. 2,481,946 illustrates a neck retainer for eyeglasses which has a small tubular member attached to a fabric strap which fits around the neck, and holds the glasses in position when the eyeglasses are actually off. The strap is to hold the glasses in place around a person's neck, rather than retain the glasses in a position during use.

A similar device is shown in U.S. Pat. No. 2,704,961 where a neck strap is utilized for retaining the eyeglasses in position when the eyeglasses are removed from the face and are supported around the neck.

U.S. Pat. No. 3,450,467 illustrates an eyeglass retainer that grips the eyeglasses and attaches to the temple pieces or bows of the eyeglasses to hold the eyeglasses in position. A neck strap for supporting eyeglasses when removed is shown in U.S. Pat. No. 3,879,804 which illustrates a band that clips onto eyeglasses or goggles and will grip the eyeglasses or goggles through a tightening loop connection. A similar type device is shown in U.S. Pat. No. 3,874,776.

U.S. Pat. No. 3,502,396 illustrates a non-stretch adjustable eyeglass holder that fits behind the head during use and has a series of holes for a fastener that provides for adjustment of the length of the strap after the strap has been attached to the temples of the eyeglasses.

Other patents that disclose eyeglass retainers include U.S. Pat. Nos. 2,539,922, 4,657,364, 4,541,696 and 4,793,702. In the later patent the inventors allege that by using a tape to form the tubes of the eyeglass retainer disclosed in U.S. Pat. No. 4,133,604, the tubes allegedly grip the temples of the eyeglass more securely than tubes made with a sewn seam.

U.S. Pat. No. 4,976,531 to Kahaney depicts an elongated tubular sleeve which is adapted to receive a temple portion of a pair of eyeglasses. A connector member, having a slot therein, can be snapped onto the rear end of the tubular sleeve. The slot receives an eyeglass retainer strap. In essence, the construction of the patent is a tube having a single hole in it. The hole receives a pin member in order to anchor the connecting piece.

A variety of patents disclose molded rubber tubes having bores open through one end for receiving the temple portion of a pair of eyeglasses and a retainer strap fused to the rear end of the tube. See U.S. Pat. No. 1,819,738 (Daniels), and U.S. Pat. No. 5,575,042 (Kalbach). Typically, these constructions retain the cord through techniques such as gluing, clamping, etc., for example, by means of a ferrule inside of the tube or other techniques to render the cord too large to pull back through the end opening of the tube, e.g., knotting. U.S. Pat. No. 5,092,668 to Welch shows a number of features of eyeglass cord retainer apparatus. Many of these features are present in devices available in the marketplace. The Welch '668 patent discloses a securement cord with a ring formed at each end, whereby each ring is mounted to an elastomeric loop. Each elastomeric loop includes a medial spring member encompassing each loop to effect an upper and lower loop with the upper loop of each elastomeric loop resiliently securing a temple leg of an eyeglass assembly.

In U.S. Pat. No. 6,000,795 a pair of elastomeric retainers are secured along temples of a pair of eyeglasses for positioning behind a person's ears. Each of these retainers can be made from molded rubber and the lower portion of each of the elastomeric retainers can be attached to a cord to form a single eyeglass retainer.

Conventional eyeglass holders or retainers are known to exhibit some undesirable and disadvantageous properties. Such undesirable attributes can be related to functional deficiencies and/or to manufacturing aspects. In regard to the latter, for instance, need for special machinery and fixturing, high labor content and/or high material cost, etc. are generally representative of disadvantageous characteristics.

Some of the prior art eyeglass holders of versions that are commonly available in the market are akin to those shown and disclosed by the Welch '668 patent. Such devices have a number of disadvantages. Loops for holding temple legs tend to lose elasticity and can thusly allow detachment of the holder cord from the temple leg. Rings, springs, adjustable collars, etc. which serve for adjustment to temple-leg size and to hold tension of the loop over the temple leg have often been found inadequate to the task; and, moreover, have added material and labor cost. They also frequently capture and pull the user's hair.

Some prior art devices, particularly those having cord-end fasteners molded in one piece or fused with ends or extension components of the cord, drastically limit the choice of cord material to only those that are not adversely affected by high-temperature molding or fusing conditions. Thus, for instance, it is difficult to fuse or heat seal leather cord effectively to end fasteners of suitable moldable elastomeric materials; and, cords of Nylon and similar plastics are apt to melt at fusing temperatures. Additionally, rigid joining of end fasteners to cords (by fusing and otherwise) requires a relatively bulky joint region, which is undesirable both for reasons of the user's inconvenience and of material and cost.

A persistent problem associated with many, if not most, conventional eyeglass holders lies with the unreliable holding capability of cord end fasteners about eyeglass temple legs, particularly since temple legs of different types of glasses significantly differ in size and shape. Although various solutions have been disclosed, many have been found to be either ineffective in the long run or costly—particularly when used in combination with other features. For example, Guthman (U.S. Pat. No. 2,780,853) discloses a metal spring clasp for attaching ends of a cord to eyeglass temples. This appears to be effective, but it is also a relatively high-cost solution. One-piece, molded cord-end fasteners of elastomeric material go a long way toward low cost, but they often pose problems with unadaptability to different temple sizes and with unreliability of attachment. In this respect, Seet (U.S. Pat. No. 4,820,036) shows an end member 20 (molded in one piece with the headband) having an opening 22 through which is passed a temple leg that is to be held securely. Whereas the end member requires relatively high resiliency and elasticity to accommodate and reliably hold different-size temple legs, the headband needs substantially less resiliency and elasticity to be effective in use.

Another solution to the need for reliable holding to different-size temples is disclosed by Seron (U.S. Pat. No. 4,136,934) wherein a holding fixture 20 at the end of a band 14 includes a tail-like projection 24 with an elongated slot 26 for receipt of one of the temples. In order to provide tight gripping for differing size temples, a projection 24 is provided with a wire band 34 whose position is adjustable along projection 24 to close the slot. Again, however, adjustable collars or wire bands, etc. have often been found inadequate to the task. Moreover, they require added material and labor cost, while frequently capturing and pulling hair.

Accordingly, it is a feature of the present invention to provide a practical and functionally convenient and effective end fastener for eyeglass holders that is reliable, cost-effective, attractive, and convenient in use.

None of the prior art patents disclose a comfortable eyeglass retainer that can securely grip many different sized temples of the eyeglasses with nearly equal strength.

### SUMMARY OF THE INVENTION

The present invention relates to an eyeglass retainer for holding eyeglasses in position on the head of the wearer during use. The retainer includes a cord or a strap and an end fastener on each end of the cord or strap. The end fasteners are made from an elastic material such as a thermoplastic elastomer which is preferably molded on the end of the chord or strap with the use of a primer to increase the adhesion between the elastomer or rubber and the cord or strap. The end fastener is preferably made from a unitary body of elastomeric material and defines a tube along one axis. This tube is adapted to accept the temple of the eyeglasses. It also includes a second tube along a second axis. The end of the cord is inserted in and attached to the second tube. The first tube preferable contains two or more ribs lining the interior and extending in the direction of the axis of the tube. The axis of the second tube preferably intersects the axis of the first tube at an acute angle, preferably between 20 and 70 degrees. A slider can be used on the cord so that the wearer can loosen or expand the effective length of the cord so as to make a tight fit on the wearer's head.

It is an object of the invention to provide an end fastener on an eyeglass retainer that needs no manual adjustment to tighten the end fastener to the temple of the eyeglasses.

Another object of the invention is to provide an end fastener on an eyeglass retainer that fits on a wide range of temples sizes and yet securely holds the thinner sized temples.

Yet another object of the invention is to provide an end fastener for an eyeglass retainer that inhibits rotation around the temple of the eyeglasses.

Still another object of the invention is to provide an eyeglass retainer that is simple to manufacture and does not have an assembled appearance.

Another object of the invention is to provide an eyeglass retainer that would fit most eyeglass frames without the need for any user adjustment.

Still other objects and advantages of the invention will in part be apparent from the specification.

The invention accordingly comprises the features of construction, combination of elements and arrangement of parts which will be exemplified in the construction hereinafter set forth and the scope of the invention will be indicated in the claims.

### BRIEF DESCRIPTION OF THE DRAWINGS

FIG. 1 is a perspective illustration of the eyeglass retainer on a pair of eyeglasses

FIG. 2. is a perspective illustration of the end fastener

FIG. 3 is a schematic cross-section of the tube of the end fastener through which the temple of the eyeglasses is to be inserted

FIG. 4 is a side view of the end fastener

FIG. 5 is a top view of the end fastener

FIG. 6 is a front view of the end fastener

### DETAILED DESCRIPTION OF THE DRAWING

The temples 1A and 1B of eyeglasses 1 shown in FIG. 1 are inserted into the end fasteners 2. End fasteners are attached to cord or strap 4. The cord or strap 4 may be inserted into a slider or bead 3 so that when the slider or bead is moved toward the temples of the eyeglasses, the effective length of the cord or strap is shortened. Similarly, when the slider or bead is moved away from the temples, the effective length of the cord or strap is increased.

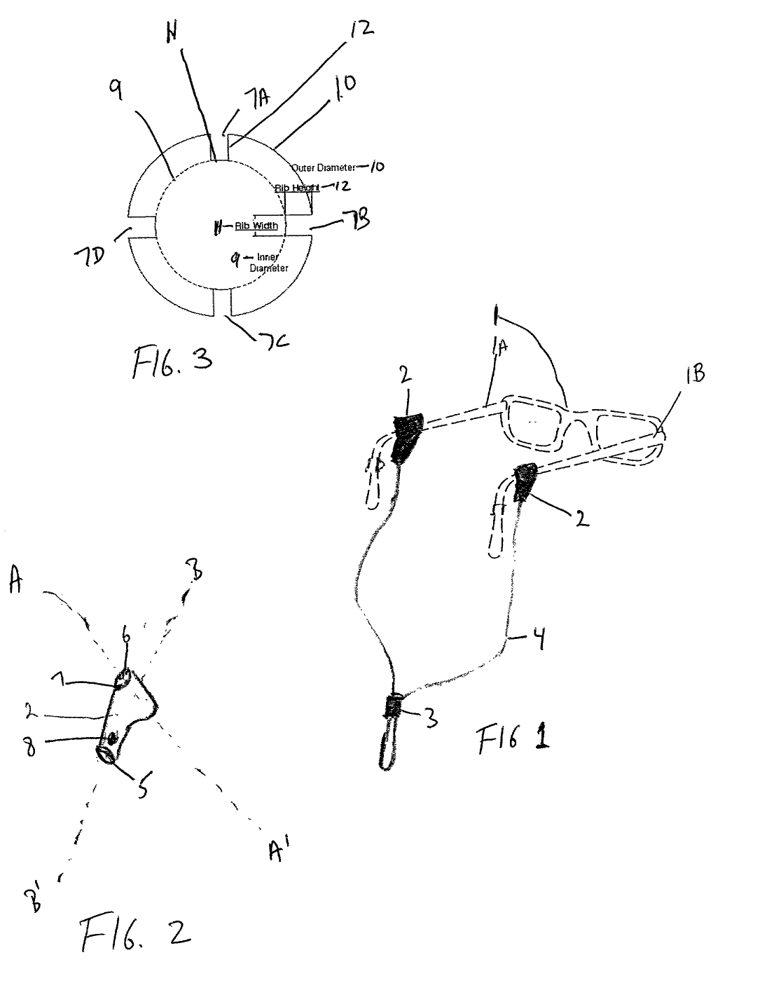

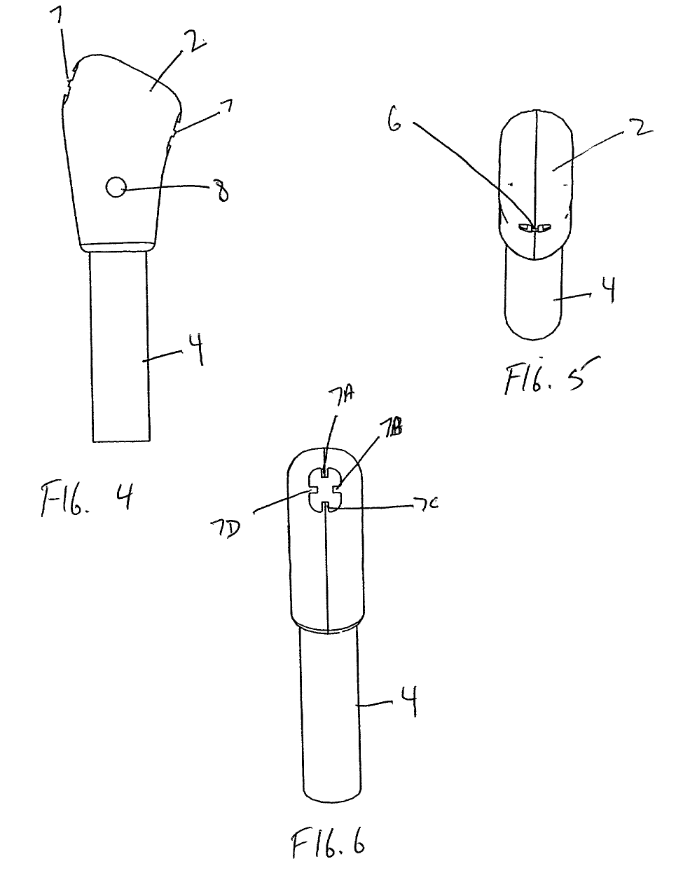

In FIG. 2 the end fastener is shown. A first end fastener 2 tube 6 is at the top the end fattener and runs in the direction of axis A-A′. A second tube 5 which runs along axis B-B′ is at the bottom of end fastener 2. Second tube 5 is of the same diameter as that of cord 4. Ribs 7 line tube 6 along the direction of axis A-A′. Preferably the axis A-A′ intersects axis B-B′ at an acute angle defined by AB or B′A′. Preferably the acute angle is between 20 and 70 degrees.

In FIG. 3 a cross section of tube 5 is shown. Ribs 7A, 7B, 7C and 7D all have a rib width 11 and a rib height 12. The effective inner diameter 9 is shown as a dotted line and the effective outer diameter of tube 5 is shown as 10. Inner diameter 9 should be small enough to hold smaller temples, preferably less than ⅛ inch. The outer diameter 10 is preferable greater than 1.25 times the inner diameter 9. The rib aspect ratio, defined as the rib height divided by the rib width, needs to be such that the ribs will be stiff enough to stand on their own while not having too great of a width. Preferably the rib aspect ratio is greater than ½ and less than 3. The number of ribs can be any number such that total combined rib width (the number of ribs multiplied by the rib width) is less then 0.75 times the circumference of the outer diameter. The ribs need not be rectangular, nor do the inner or outer diameters need to be circular.

The end fasteners 2 are made of an elastic material such as a hard rubber made from a thermoplastic elastomer. The end fastener is preferably made by direct insert molding the thermoplastic elastomer onto the end of cord 4. Said end is treated with a primer prior to molding to increase the adhesion between the rubber and the cord. The molding is preferably done on a vertical injection molding machine made expressly for insert molding.

The mechanics of how the end fastener grips the temples of the eyeglasses can be broken down into three attributes. The first is best described by thinking about the tube end 5 as a rubber band. For any given rubber band, there is a minimum size object that it will hold to as well as a maximum size object over which it can stretch. The minimum size is a related to the relaxed size of the rubber band and the maximum size is related to the rubber bands ability to stretch before breaking. By adding ribs to the inside of tube 5 or the imagined rubber band one can decrease the minimum size object (or temples of the eyeglasses in the case of tube 5) that it will grip. The ribs will also reduce the maximum size of object (or temples of the eyeglasses) over which the rubber band (or tube 5) will stretch. It can be now understood that the range of diameters of the temples of eyeglasses 1 is increased by the addition of ribs 7.

For example if one assumes that tube 5 has the ability to stretch such that the maximum diameter temple over which it can stretch is equal to 4 times the minimum size it will grip. In the example, assume that ribs 7 reduce the minimum size object that it can grip to in half. This implies that ribs that are ½ of the tube 5 radius in height. The maximum size would also be reduced by 1/2 times the minimum size giving a range of fits from 0.5-3.5 times the minimum size of the non ribbed tube or a range of 1-7. This range is much better than the original range of 1-4.

The second attribute has to do with the geometry of the end fastener. When fitted to a small temple eyeglass the only points of contact will be the ends of the ribs. When fitted to a larger temple the part will deform to produce greater amounts of contact. This deformation of the part is not the same as a straight stretching but is instead a bending of the cross section producing stresses inside the part, which do not act uniformly like stretching stresses.

The third attribute is that while most of the end fastener is in tension, the ribs 7 are in compression. This helps to increase the range of fit while decreasing the maximum stress in the area around the ribs.

It will thus be seen that the objects set forth above, among those made apparent from the preceding description, are efficiently attained and, since certain changes may be made in carrying out the above improved closure for an eyeglass retainer without departing from the spirit and scope of the invention, it is intended that all matter contained in the above description and shown in the accompanying drawings shall be interpreted as illustrative and not in a limiting sense.

It is also understood that the following claims are intended to cover all of the generic and specific features of the invention herein described, all statements of the scope of the invention which as a matter of language might be said to fall therebetween.

What is claimed is:

1. An eyeglass retainer comprising a cord, an end fastener for attaching the end of said cord to a temple of eyeglasses, said end fastener comprising a unitary body of elastomeric material which forms a first tube along a first axis adapted to accept the temple of the eyeglasses and also forms a second tube along a second axis, wherein said second tube is adapted to receive said cord and is molded to said cord.

2. The eyeglass retainer of claim 1 wherein the first tube comprises two or more elastomeric ribs lining the interior of said first tube.

3. The eyeglass retainer of claim 2 wherein said first axis intersects said second axis at an acute angle.

4. The eyeglass retainer of claim 3 wherein said angle is between 20 and 70 degrees.

5. The eyeglass retainer of claim 2 wherein said eyeglass retainer has been manufactured by pre-treating the end of said cord with a primer and wherein said elastomeric material is a thermoplastic elastomer; said cord being attached to said second tube by insert molding said thermoplastic elastomer on the end of said cord.

6. An eyeglass retainer comprising a cord, an end fastener for attaching the end of said cord to a temple of eyeglasses, said end fastener comprising an elastomeric material which forms a first tube along a first axis adapted to accept the temple of the eyeglasses and a second tube along a second axis, wherein said second tube is adapted to receive said cord; said first tube further comprising two or more elastomeric ribs lining the interior of said first tube.

7. The eyeglass retainer of claim 6 wherein said first axis intersects said second axis at an acute angle.

8. The eyeglass retainer of claim 7 wherein said angle is between 20 and 70 degrees.

9. The eyeglass retainer of claim 6 wherein said eyeglass retainer has been manufactured by pre-treating the end of said cord with a primer and wherein said elastomeric material is a thermoplastic elastomer; said cord being attached to said second tube by insert molding said thermoplastic elastomer on the end of said cord.
